(19) United States
(12) Patent Application Publication
(10) Pub. No.: US 2026/0185011 A1
(43) Pub. Date: Jul. 2, 2026

(54) PLASTIC COATING FOR A CABLE WITH SLIDING PROPERTIES

(71) Applicant: Conductores Monterrey S.A. de C.V., San Nicolás de los Garza (MX)

(72) Inventors: Cesar Nadem MUÑOZ LOPEZ, San Nicolás De Los Garza (MX); Cecilia Giovana CASTILLO SOSA, San Nicolás De Los Garza (MX); Juan Agustín ARROYO CABALLERO, San Nicolás De Los Garza (MX); Arturo GARCÍA REYNA, San Nicolás De Los Garza (MX)

(21) Appl. No.: 19/433,421

(22) Filed: Dec. 26, 2025

Related U.S. Application Data
(60) Provisional application No. 63/739,329, filed on Dec. 27, 2024.

(51) Int. Cl. C10M 169/04; C10M 107/04; C10M 107/38; C10M 133/16; C10M 155/02; C10M 161/00; C10M 177/00; C10N 40/32; C10N 50/08; C10N 70/00; H01B 3/44; H01B 13/14

(52) U.S. Cl. CPC C10M 169/044; C10M 107/04; C10M 107/38; C10M 133/16; C10M 155/02; C10M 161/00; C10M 177/00; H01B 3/441; H01B 13/141; C10M 2205/0225; C10M 2213/023; C10M 2215/08; C10M 2229/02; C10N 2040/32; C10N 2050/08; C10N 2070/00

(57) ABSTRACT

The present invention relates to a thermoplastic coating for medium-voltage cables, specifically designed to improve sliding properties. This innovative coating solution addresses the technical problem of reducing the time and effort required for cable installation by decreasing the coefficient of friction between the cable surface and the conduit walls. The invention utilizes a unique formulation of LLDPE and PVC compounds, incorporating specific additives such as stearyl erucamide, behenamide, oleamides, and N,N′ ethylene Bisoleamide (EBO). Additionally, UV light stabilizers are included to protect the cable from degradation over time. The overall result is a coating that effectively reduces friction and significantly improves ease of installation. The system allows cables to be smoothly inserted into electrical conduits, even in challenging environments.

### CROSS-REFERENCE TO RELATED APPLICATIONS

This application claims priority from U.S. Provisional Application No. 63/739,329, filed on Dec. 27, 2024, which application is hereby incorporated in its entirety by reference in this application.

### FIELD OF THE INVENTION

The present invention relates generally to a thermoplastic coating for medium-voltage cables, specifically designed to improve the cable's sliding properties through conduits without the need for external lubricants. The present invention is applicable in the electrical infrastructure sector, facilitating cable installation in industrial and commercial environments.

### BACKGROUND OF THE INVENTION

Medium-voltage cables are fundamental elements in the electrical distribution infrastructure, enabling the efficient transport of energy at voltage levels that generally range between 1 kV and 36 kV. The mechanical integrity and electrical performance of these cables depend largely on their coatings, which must provide electrical insulation, weather resistance, and ease of installation.

One of the main challenges in the installation and maintenance of these cables is the friction generated between the cable's outer coating and the ducts or conduits through which it is inserted. This friction makes installation difficult and can cause mechanical damage to both the coating and the inner conductor. To overcome this problem, lubricants have been developed for external application to the cables, in order to have improved sliding properties through the use of compounds and/or additives with a low coefficient of friction.

However, this practice presents several disadvantages, such as the accumulation of residue inside the conduits, affecting the quality of the installation and requiring frequent maintenance of the electrical conduits; it also causes the inconvenience of acquiring these external lubricants, as well as the need for specialized labor for their application; likewise causing possible long-term technical failures due to the degradation of the thermoplastic coatings of the cable with the interaction with the lubricants.

Presently, there are cable coating materials that include thermoplastic polymers with various formulations to improve mechanical and electrical properties. However, these materials do not offer an optimal solution that allows for efficient sliding without compromising cable integrity.

Such is the case of patent application CN110791011A published on Nov. 11, 2019, which describes a low-smoke, halogen-free, flame-retardant elastomer cable material by 150° C. irradiation crosslinking and a method for preparing the same, wherein the cable material is prepared from the following components: 10-40 parts of ethylene vinyl acetate rubber (EVM); 10-40 parts of ethylene propylene diene monomer (EPDM); 5-20 parts of polyolefin resin; 0-20 parts of a plasticizing system; 20-40 parts of a flame-retardant system; 20-40 parts of a smoke-reducing system; 1-8 parts of a synergistic flame-retardant system; 0.5-3 parts of an anti-aging system; 0.2-3 parts of a lubricating system; 0.2-1 parts of an anti-ultraviolet system; 0.5-3 parts of a crosslinking sensitization system. After irradiation crosslinking, the wire and cable prepared from the cable material disclosed in said patent publication have superior physical and mechanical properties, excellent electrical insulation performance, resistance to chemical media, flame retardancy, and heat resistance, and can meet the requirement of a cable with a long-term working temperature of 150° C. The irradiation dose of the cable material is 10-20 Mrad.

Similarly, patent CN108003602B, published on Feb. 5, 2021, discloses a thermoplastic polyurethane composite material for an optical cable and cable coating, which is prepared mainly from the following raw materials in parts by weight: 15-35 parts of TPU1, 30-60 parts of TPU2, 10-30 parts of continuous long fiber, 0.1-10 parts of compatibilizer, 0.1-6 parts of lubricant, 0.2-5 parts of antioxidant, and 0-35 parts of flame retardant. The thermoplastic polyurethane composite material obtained in said patent has excellent tensile strength, rigidity and wear resistance, and simultaneously has the performance of high toughness, hardness, elasticity, oil resistance, chemical corrosion resistance, weather resistance, tensile strength, extrusion resistance and the like; it can form a good product surface, has higher impact resistance and higher wear resistance, it can meet the performance requirements of high-performance cables and optical cable coating materials, and is used in the special application fields of wind power cables, submarine optical cables and the like.

Similarly, patent CN118290926B, published on Oct. 1, 2024, discloses a focus on high molecular weight cable materials and claims a halogen-free, flame-retardant polyurethane cable coating material and a method for the preparation thereof. The halogen-free, flame-retardant polyurethane cable coating material, as applied, comprises the following raw materials: thermoplastic polyurethane elastomer, linear low-density polyethylene, ethylene propylene diene rubber, compatibilizer, antioxidant, crosslinking agent, and a filler-type flame retardant, wherein the filler-type flame retardant is modified boron nitride, said modified boron nitride is composed of a maleic anhydride-sodium lignin sulfonate graft copolymer, the nanometric boron nitride sheet is modified with dimethylaminoethyl acrylate and propylene phosphate. The material obtained in said patent for halogen-free flame-retardant polyurethane cable coating in application has good mechanical strength and toughness, which can achieve high-efficiency flame retardancy and reduce the release of toxic smoke at the same time, and can be widely applied in various industrial, agricultural and domestic occasions.

Furthermore, patent application CN111690201A, published on Sep. 22, 2020, discloses a low-friction, low-smoke, halogen-free, flame-retardant polyolefin cable material and a method for the preparation thereof, and pertains to the technical field of cable materials. The raw materials comprise: matrix resin, flame-retardant filler, hydrophobic surfactant, compatibilizer, sliding agent, and antioxidant; the matrix resin comprises ethylene-vinyl acetate copolymer and propylene-ethylene copolymer; the flame-retardant filler comprises aluminum hydroxide and magnesium hydroxide; the sliding agent comprises oleamide and silicone masterbatch. The preparation method described in said application comprises the following steps: heating the ethylene-vinyl acetate copolymer to a molten state, and spraying an aqueous solution of hydrophobic surfactant onto the material while stirring to obtain a first mixture; add the flame retardant filler, the sliding agent, the compatibilizer, and the antioxidant to the first mixture, and mix uniformly to obtain a second mixture, and carry out high-pressure banburizing; and mix and granulate the first mixture, the second mixture, and the propylene-ethylene copolymer to obtain a final product.

Finally, patent application CN109456527A, published on Mar. 12, 2019, discloses a flame-retardant PE cable coating material of a low-friction type and a method for preparing the same. The cable coating material includes materials such as 20-50 parts of high-density polyethylene (HDPE), 10-30 parts of low-density polyethylene (LDPE), 10-25 parts of ethylene-methacrylic acid copolymers, 5-25 parts of ethylene-vinyl acetate copolymers, and 60-100 parts of flame-retardant compounds. The material described in said application is made by the homogeneous mixture of materials of said components, a type of excellent flame-retardant performance can be obtained, the vertical combustion degree reaches V0 grades and the coefficient of friction up to 0.08 of the cable coating material, the class A combustion acceptability criterion of bundled cable can be achieved when it is converted into bundled cable, the excellent flame retardant property and the lower coefficient of friction can satisfy the cable coating material in actual use for the demand of multiple performances such as flame retardant property and antistatic performance.

Based on the teachings learned from the prior art, it is clear that, to date, there are still limitations that prevent complete optimization of the performance of medium-voltage cables, wherein some sliding additives present compatibility problems with the polymer matrices of known coatings, negatively affecting the quality of the coating; these lubricating agents are also deposited on the surface of the conduits, reducing sliding efficiency and compromising the dielectric strength of the coating, which can affect the operational safety of the cable.

Therefore, there is a need to develop a coating with a low coefficient of friction, avoiding the loss of sliding properties in the long term, which facilitates installation in ducts of considerable lengths and complex geometries, as well as high mechanical resistance allowing it to withstand tensile stresses during installation without compromising the integrity of the cable.

### SUMMARY OF THE INVENTION

It is therefore an objective of the present invention to provide a coating for voltage cables that, according to a composition of a specific formulation based on thermoplastic resin and a specific combination of additives, substantially reduces the coefficient of friction of the cable, offering superior sliding properties.

Furthermore, a specific objective of the present invention is to provide a thermoplastic coating applicable to medium voltage cables.

Another objective of the present invention is to provide a coating for voltage cables with sliding properties by means of the inclusion and combination of additives such as polysiloxane, stearyl erucamide, behemide, erucamide, N,N′ ethylene Bisoleamide EBO, stearamide, ethylene bis stearamide; these components allow a significant reduction in the coefficient of friction, resulting in the coating sliding with less resistance to friction generated by the outer cable coating and ducts, reducing installation time.

Similarly, another objective of the present invention is to provide a coating for voltage cables incorporating silicone additives, particularly silanes and siloxanes, where the adhesion between the polymer and the sliding additives is improved, as well as the thermal stability of the formulation during its production and operational life, also ensuring that the material remains stable and durable when exposed to high temperatures both in its processing and in its use, which contributes to the overall strength of the cable coating, making it suitable for environments where temperature fluctuations or excessive heat may represent a challenge.

### BRIEF DESCRIPTION OF THE FIGURES

FIG. 1 shows a Henschel machine for mixing powders.

FIG. 2 shows the thermoplastic resin mixing equipment: (a) Brabender machine for mixing compounds based on PVC, Polypropylene and linear low-density polyethylenes and low-density polyethylenes, (b) Hydraulic press, (c) equipment for measuring the coefficient of friction (CoF) at plate level.

FIG. 3 is a graph illustrating the FTIR spectra for three samples of PVC-based formulated compound. The blue line corresponds to Formulation 1.1 with a sliding additive, the black line corresponds to Formulation 1.2 without a sliding agent, and the red line corresponds to Formulation 1.2 with a sliding agent.

FIG. 4 is a graph showing the friction coefficients as a function of the concentration of the sliding agent using the commercial additive polysiloxane-III.

FIG. 5 is a graph showing the coefficients of friction as a function of the concentration of the sliding agent using the commercial additive polysiloxane-III on different thermoplastic polymer bases.

FIG. 6 is a graph showing the friction coefficients for the linear polyethylene polymer matrix, polypropylene with added sliding agent of the polysiloxane-I type.

FIG. 7 is a graph showing the friction coefficients for the linear low-density polyethylene polymer matrix and low-density polyethylene with added sliding agent stearyl erucamide.

FIG. 8 is a graph showing the friction coefficients for the linear low-density polyethylene polymer matrix and low-density polyethylene with added sliding agent ethylene bis stearamide.

FIG. 9 is a graph showing the friction coefficients for the polypropylene polymer matrix additive with Polysiloxane-I sliding agent.

FIG. 10 is a graph showing the friction coefficients for the Polypropylene polymer matrix with added sliding agent ethylene bis stearamide.

FIG. 11 is a graph showing the friction coefficients for the Polypropylene polymer matrix with added sliding agent stearyl erucamide.

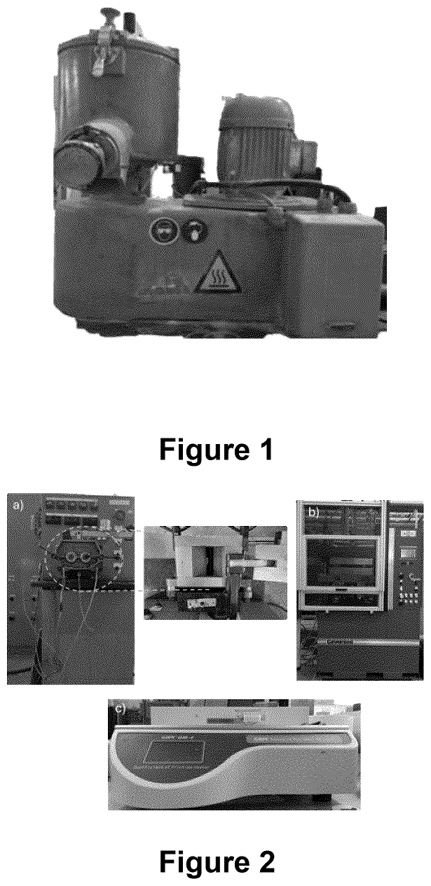

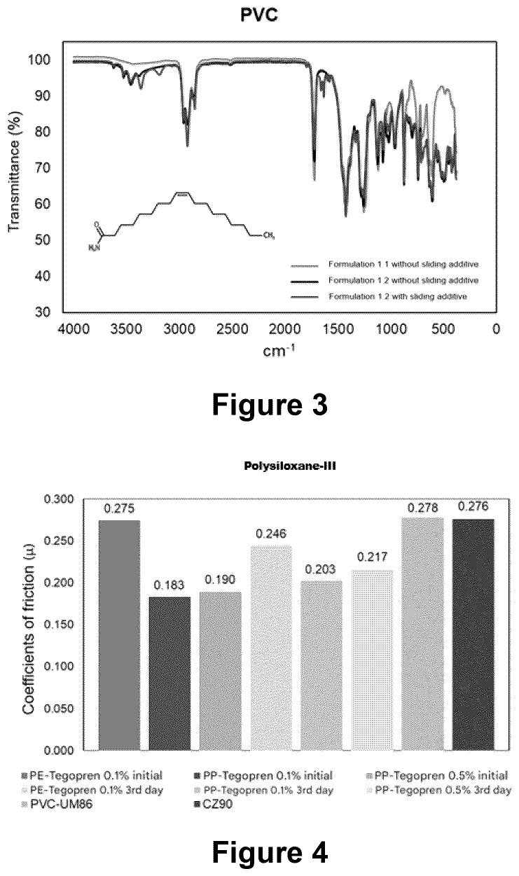

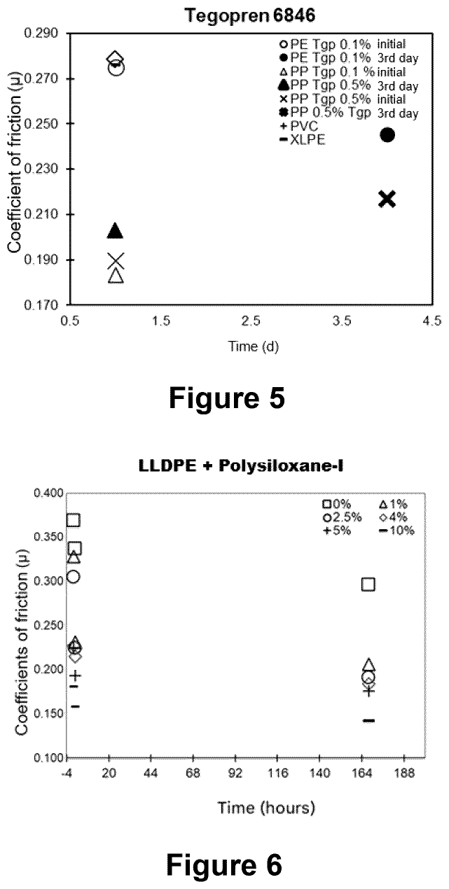

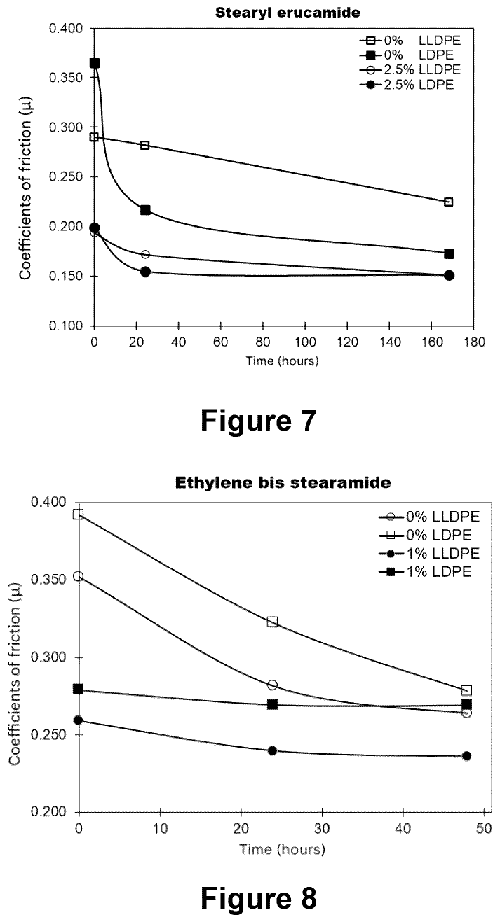

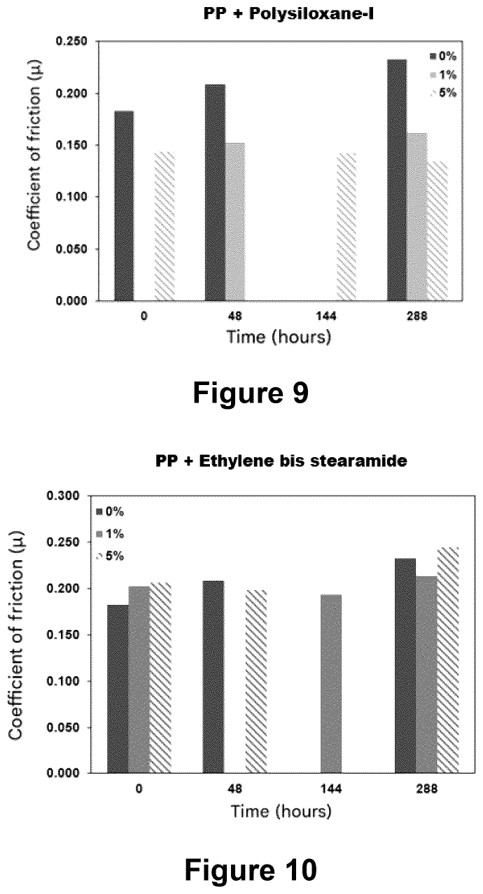

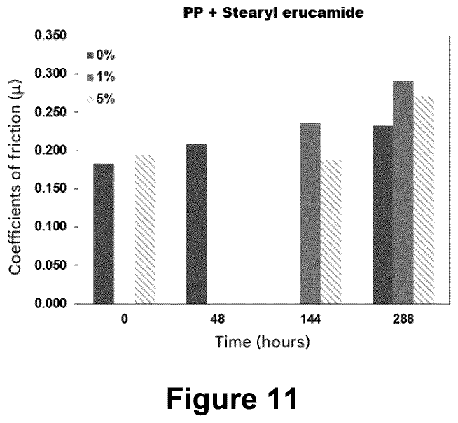

### DETAILED DESCRIPTION OF THE INVENTION

Some aspects of the present invention will now be described in more detail, also using reference to the accompanying drawings which show some embodiments and advantages of the present invention.

It will be evident to a person skilled in the art that various embodiments of the invention can be expressed in different ways and should not be interpreted as being limited to the embodiments described herein; rather, these exemplary embodiments are provided to make this invention clear and complete and to fully convey the scope of the invention to those skilled in the art. For example, unless otherwise indicated, something described as first, second, or similar should not be interpreted as a particular order. As used in the description and in the appended claims, the singular forms “a,” “an,” “the,” and “a” include plural referents unless the context clearly indicates otherwise.

The different aspects of the present invention relate to a thermoplastic coating with a low coefficient of friction for medium-voltage cables, based on a combination of thermoplastic polymers and functional additives. In particular, each of the components described later plays a fundamental role in achieving the main objective of the present invention, which is the reduction of the coefficient of friction.

This solution arises from the need to provide a substantial improvement during the process of installing voltage cables within electrical infrastructures, in which a low coefficient of friction is a key aspect to ensure the ease of handling of the system, which will be described later in this document.

Furthermore, the present invention differs in the joint incorporation of compounds, obtaining a coating which substantially improves the mechanical and sliding properties of the cable, ensuring adequate performance under demanding conditions; it should be noted that the specific combination of compounds, in its different embodiments described later in the present invention, offers a different result not previously achieved in the cited prior art, since, as previously mentioned in this document, current teachings have not achieved a specific combination with similar compounds that achieve a true bond, comprehensively improving the effects of a low coefficient of friction.

Regarding the improvement of mechanical resistance, it is important to highlight that the coating of the present invention is able to reduce the coefficient of friction of the cable to which it is applied, which facilitates the installation of the cables, especially in confined spaces or narrow conduits.

In this way, the high sliding of the cable coating, allowing effortless passage through confined spaces, represents a substantial advantage in hard-to-reach environments such as ducts or underground installations. By reducing friction, the coating described herein enables a more efficient and effective installation, decreasing labor effort and costs. Furthermore, the high sliding properties allow minimizing and reducing the possibility of damaging the cable during installation, ensuring the insulation remains intact so that the cable works according to its specified lifespan. Similarly, the high sliding coating prevents cables from stopping during installation, which could cause delays or potential damage to both the operator and the coating itself. This feature not only increases installation efficiency but also enhances the safety of the operators involved, reducing the likelihood of physical injuries during the installation process.

Therefore, the coating composition in any of the embodiments described later in this invention provides greater installation efficiency. As a result, this invention offers a high level of practicality in real-world applications.

Furthermore, the present invention comprises multiple and significant technical advantages that derive directly from the novel formulation and the specific combination of its components, overcoming the limitations present in the prior art.

One of the primary advantages of the formulation of the present invention lies in the complete elimination of the need to apply external lubricants during the installation of the cable in the ducts or conduits, where, such elimination, provides an advantageous solution directly to the problems set forth in the background section, in particular, to those where the conventional practice of external lubrication not only generates significant additional costs associated with the acquisition of such lubricating compounds, but also increases installation times.

More specifically, as is known within the field, the need for labor, sometimes specialized, for the correct application of these sliding agents on the cable coating or inside the conduits, generates a substantial increase in the project's total operating costs, not only due to the direct personnel expenses but also because of the need for specialized training to ensure that the lubricant is applied consistently and meets the required specifications, preventing both material waste and inadequate lubrication. This reliance on a manual process inevitably introduces significant delays in the installation schedule, making lubricant application a bottleneck that impacts the overall efficiency of cable laying. Furthermore, this manual process is inherently susceptible to human variability and a lack of uniformity, which can lead to inconsistent application that compromises the effectiveness of cable sliding in certain sections and directly contributes to the residue accumulation problems that the process aims to prevent.

The above implies a relevant technical problem, since it generates additional logistical complexity, tying the progress of the installation to the availability and management of work teams dedicated to this specific task.

Moreover, the coating of the present invention, in its various embodiments, advantageously avoids logistical and maintenance inconveniences, such as the accumulation of lubricant residue in the conduits, which can affect future installations or their quality, since, being intrinsically slidable, the invention optimizes the logistics of the installation, simplifies the process and reduces dependence on secondary consumables.

As a direct consequence of its unique composition, the present invention provides a substantial reduction in the coefficient of friction at the interface between the outer cable coating and the inner walls of the conduit, thereby providing significantly superior performance compared to conventional coatings that lack the specific formulation based on the present invention.

With this, cables coated with the present invention demonstrate a notable and advantageous improvement during the installation process in narrow conduits. In particular, and as will be evident after a comprehensive reading of this application and, especially, the results presented in the examples section, the coating of the present invention offers reduced frictional resistance that is achieved through the controlled migration and synergy of additives such as amides and silicone additives to the polymer surface, allowing the cable to be inserted and pulled through the conduits with significantly less effort. This facilitates installation in long runs or with complex geometries, such as tight bends, vertical sections, or confined spaces. This ease of installation not only accelerates the process but also minimizes the risk of mechanical damage to the cable or jamming during laying, protecting the integrity of the inner conductor and the coating itself, which in turn increases operator safety.

Unlike prior art palliative solutions that rely on surface and temporary agents, the present invention ensures a longer service life for the coating and its functional properties. This is because the sliding additives—such as stearyl erucamide, behemide, erucamide, EBO, stearamide, EBS, and silicone additives (silanes and siloxanes)—are not applied topically, but are incorporated and homogeneously distributed within the polymer matrix (e.g., PVC, PE, LLDPE) during the manufacturing process. This molecular integration, often facilitated by coupling agents such as adhesion-enhancing silanes, ensures that the sliding properties are permanent and do not degrade through simple use, cleaning, or the passage of time. Furthermore, it avoids the compatibility or long-term degradation problems that external lubricants can cause in thermoplastics.

Additionally, this comprehensive formulation provides enhanced resistance to abrasion and environmental agents. The coating is designed to withstand the mechanical wear inherent in friction during installation and operation. Furthermore, thanks to the inclusion of UV stabilizers, such as benzophenones or HALS, the degrading effects of ultraviolet radiation and photo-oxidation are mitigated—a critical factor for cable durability in exposed installations. This combined robustness extends the cable's operating life and significantly reduces the need for frequent maintenance.

From a manufacturing and industrial implementation perspective, a crucial technical advantage is the formulation's complete compatibility with standard extrusion processes. The mixing of the base polymer and specific combination of additives were selected not only for their final functional properties but also for their excellent processability. This means that cable manufacturers can adopt this technology without requiring significant or costly modifications to their existing production lines, utilizing conventional extrusion machinery and familiar mixing and cooling processes. This enables efficient and cost-effective industrial-scale production.

Finally, and crucially, the incorporation of sliding and stabilizing additives does not compromise the fundamental properties required for the product's primary application. The final coating maintains optimal mechanical, electrical, and thermal resistance. The composition ensures compliance with stringent safety and performance standards for cables, particularly medium-voltage cables, providing the dielectric strength and thermal stability necessary for safe and reliable long-term operation.

In a first embodiment of the present invention, the coating of the present invention comprises:
a) At least one base polymer: This base component forms the main matrix of the coating and provides mechanical strength, flexibility, and thermal stability. This compound is chosen for its compatibility with extrusion processes and its ability to retain the sliding additives without losing structural mechanical properties.

In one embodiment, the at least one base polymer comprises polymeric materials, particularly thermoplastic materials, wherein they are selected from the group comprising polyvinyl chloride (PVC), polyethylene (PE), high-density polyethylene (HDPE), low-density polyethylene (LDPE), linear low-density polyethylene (LLDPE), polypropylene (PP), polyamides (PA, Nylon) and combinations thereof.

In another embodiment, the at least one base polymer comprises a dielectric strength that is in the range of 20 to 40 kV/mm, as well as a density that is in the range of 1.3 to 1.45 g/cm³.

In another embodiment, the at least one base polymer comprises a dielectric strength that is in the range of 30 to 50 kV/mm, as well as a density that is in the range of 0.915 to 0.930 g/cm³.

In another embodiment, the at least one base polymer is in a range from 70% to 90% of the concentration in the final composition.
b) At least one additive with highly sliding characteristics: These components are essential to the present invention, as they improve properties such as surface lubricity, processability, and wear resistance. These components reduce friction between cables and electrical conduits during installation, improve extrusion, and can optimize performance under environmental conditions.

The additives with highly sliding characteristics used in the present invention will now be described:
i) Stearyl Erucamide: long-lasting sliding additive with anti-blocking and friction-reducing properties in polymers used to reduce friction between the layers of the present invention.

In one embodiment, stearyl erucamide is used in combination with thermoplastic polymers such as polyethylene (PE) and polypropylene (PP) at low concentrations to prevent excessive exudation while maintaining the dielectric integrity of the cable.

In another embodiment, stearyl erucamide is found in a range from 0.1% to 5% concentration in the final composition.

In another embodiment, stearyl erucamide is found in a range from 0.5% to 2% concentration in the final composition.
ii) Behemide: internal and external lubricant with anti-blocking effect, which forms a low friction film reducing mechanical wear on the surface of the polymer coating described in the present invention.

In one embodiment, behemide is compatible with polyolefin and PVC polymers, especially where resistance to adhesion between layers of the described coating is sought.

In another embodiment, behemide is found in a range from 0.01% to 2% of the concentration in the final composition.

In another embodiment, behemide is found in a range from 0.1% to 1% of the final composition.
iii) Erucamide: compound used as a migratory sliding agent, reducing the dynamic friction coefficient with lower volatility compared to other amides between the coating described in the present invention and the inner surface of the duct.

In one embodiment, erucamide is found in a range from 0.1% to 8% concentration in the final composition.

In another embodiment, erucamide is found in a range from 1% to 5% concentration in the final composition.
iv) N,N′ ethylene Bisoleamide EBO: compound used as a sliding and dispersing agent with an anti-blocking effect, causing an improvement in the mechanical resistance of the coating described in the present invention.

In one embodiment, the N,N′ ethylene Bisoleamide EBO is used in combination with other additives to improve thermal stability and compatibility with the polymers used herein.

In another embodiment, N,N′ ethylene Bisoleamide EBO is found in a range from 0.01% to 5% concentration in the final composition.

In another embodiment, N,N′ ethylene Bisoleamide EBO is found in a range from 0.1% to 5% concentration in the final composition.
v) Stearamide: compound that reduces friction and acts as an anti-blocking agent, particularly improving cable demolding during extrusion.

In one embodiment, stearamide is configured to be used in combination with erucamide, resulting in improved lubricating effect without compromising thermal stability.

In another embodiment, stearamide is found in a range from 0.01% to 2% of the final composition.

In another embodiment, stearamide is found in a range from 0.1% to 1% of the concentration in the final composition.
vi) Ethylene bis stearamide (EBS): compound used as an internal and external lubricant with an anti-stick effect, achieving a substantial improvement in the processability of polymers.

In one embodiment, ethylene bis stearamide is configured to be applied in halogen-free formulations to optimize thermal resistance without affecting dielectric properties.

In another embodiment, ethylene bis stearamide is found in a range from 0.01% to 2% of the final composition.

In another embodiment, ethylene bis stearamide is found in a range from 0.1% to 1% of the final composition.
vii) At least one silicone additive (silanes and siloxanes): compounds used to improve the lubricity, thermal resistance, and hydrophobicity of the described coating, as well as improve extrusion and flexibility during its manufacturing process. In particular, silanes act as coupling agents, and siloxanes reduce surface friction.

In one embodiment, at least one silicone additive is configured to be specifically formulated in silicone emulsions, where the distribution of the additive in polymer matrices is improved without affecting the chemical stability of the cable.

In another embodiment, at least one silicone additive is found in a range from 0.1% to 10%-15% of the concentration in the final composition.

In another embodiment, silicone additives are found in a range from 0.5% to 5% 10% of the concentration in the final composition.
c) At least one UV stabilizer: compounds used in the formulation of cable coatings based on polymers with low UV resistance. Their main function is to mitigate the degrading effects of ultraviolet (UV) radiation, which can cause discoloration, embrittlement, and a reduction in the material's mechanical properties due to photo-oxidation.

“Photo-oxidation” refers to the reaction of polymers when exposed to ultraviolet, visible, or infrared radiation (such as heat, light, air, water, and radiation), resulting in changes to their chemical composition and molecular weight. These reactions modify the polymer's physical and optical properties. Once this process begins, a chain reaction occurs that accelerates degradation, creating radical molecules (R*) which are highly reactive, causing cracking, blemishes, discoloration, and loss of physical properties.

In one embodiment, the at least one UV stabilizer is any compound selected from the group comprising UV (UVA) absorbers such as benzophenones, benzotriazoles, triazines; free radical scavengers (HALS) such as hydroxybenzoates, Bis 2,2,6,6-tetramethyl-4-piperidyl, oxalanilides, carboxylic acid compounds, phosphites, and arylsulfuric acids and combinations thereof and/or similar.

In another embodiment, at least one UV stabilizer is found in a range from 0.2% to 1% of the final composition.

In another embodiment, at least one UV stabilizer is found in a range from 0.3% to 0.8% of the final composition.

Thus, the combination of all the compounds described above allows for a bonding of these compounds, giving the present invention technical features configured to overcome the cited prior art, as well as conventional materials used in this field, resulting in a complete solution that optimizes electrical installations in complex and confined conduits. Each compound has been carefully selected and dosed to ensure that the coating provides high sliding, reducing wear on the coating itself during installation, as well as on the infrastructure.

After generating the composition described above in the present invention, a cable with the coating claimed herein is produced by a simple extrusion method. The prior art for manufacturing coatings for voltage cables comprises the following steps:
Preparation of materials: The precise dosage of the base polymers and additives with highly sliding characteristics is carried out.
Mixing and homogenization: A high shear mixer is used to achieve a uniform distribution of the additives.
Extrusion: The mixture is heated and extruded over the voltage wire through an extrusion nozzle by an extrusion machine.
Cooling and solidification: Controlled cooling systems are used to prevent deformations in the coating.
Winding and cutting: The coated cable is cut and wound according to specifications.

Thus, after the coating manufacturing process described herein, it results in a highly sliding voltage cable with a reduced coefficient of friction, high mechanical and electrical strength, thermal stability and resistance to aging, resulting in easy installation without lubricants, guaranteeing a long service life of the final product, as well as compatibility with conventional extrusion processes, allowing its production on an industrial scale.

Likewise, it is important to mention that the coating claimed in the present invention is configured for use on any voltage cable selected from the group comprising low voltage electrical cables, medium voltage electrical cables, cables for telecommunications, cables for medical applications, cables in automotive harnesses, aerospace control and communication cables, cables for industry 4.0, cables for industrial robotics, cables for 3D printing and CNC devices, cables for the utilization of renewable energies and any field that requires insulation solutions with highly sliding properties.

### Examples

Having thoroughly explained each of the features of the present invention, as well as described the different examples of embodiments that the invention adopts, bearing in mind that said examples of embodiments described in this application should not be taken or interpreted in any way as limitations of the present invention, on the contrary, said examples of embodiment are intended in every sense to support the understanding of the operation of the system being provided by the user and to allow a comprehensive understanding of how the composition with the plurality of specific components described in the present invention; the invention is capable of, in addition to providing a novel composition with the ability to generate a highly sliding voltage cable coating, but also, with said added value, the composition is able to offer a solution or provide an advantageous response according to the needs set forth herein.

Having said that, the following will describe in more detail these examples of non-limiting embodiments:

This formulation is characterized by the fact that it is composed of
a)

TABLE 1
Raw materials used in different formulations.

| Raw material | Supplier | CAS |
|---|---|---|
| PVC Resin Grade 1300F | Shintech | 9002-86-2 |
| TOTM | KEMEK | 3319-31-1 |
| DOTP/Jayflex DIDP-E | KEMEL | 6422-86-2/68515-49-1 |
| Epoxidized soybean oil | EIQSA | 8013-07-08 |
| Calcium carbonate | OMYA | 1317-65-3 |
| Apyral 60D micron 1500 | HUBBER | 21645-51-2 |
| Antimony trioxide - Campine | CAMPINE | 1309-64-4 |
| Zinc oxide | Azinsa Oxides | 1314-13-2 |
| Calcium stearate | SM Corporation | 1592-23-0 |
| UV(Tinuvin)(Hostavin) | BASF | 1843-05-6 |
| Irganox/Songnox 1076-M | SONGWON | 2082-79-3 |
| Bisphenol-A | AURUM | 80-05-7 |
| TR-121 | AURUM | 301-02-0 |
| LLDPE, DFDA-7530 NT | DOW | 9002-88-4 |
| LDPE, DFDA-1216 NT | DOW | 9002-88-4 |
| PP, PTG-PPH 12 | POLNAC | 9003-07-0 |
| Polysiloxane-I | Polymers Bag | 63148-53-8 |
| Polysiloxane-II | Polymers Bag | 63148-53-8 |
| Polysiloxane-III | EVONIK | Confidential |
| Stearyl erucamide | Fine Organics | 10094-45-8 |
| Ethylene bis stearamide | CLARIANT | 110-30-5 |

### Henschel

The homogenization of the raw material in powder and viscous liquid form was carried out using the rotary grinding equipment of the commercial brand “Henschel”-Rheinstahl Henschel AG Kassel, Mod, 800645, Germany, 1985, with a capacity of 10 L. This equipment was used solely for the manufacture of materials containing PVC. Two formulation lines based on PVC resin were prepared; this formulation is described according to Table 2. Initially, a quantity of 1800 g was added to each formulation.

To achieve this, four different processes were used for the homogenization of the raw materials, which are listed below:
a) 3400 rpm (revolutions per minute)
a) 75° C. addition of plasticizer
b) 90-95° C. addition of loads (extra components)
c) 115° C. discharge process

In this way, a homogeneous powder mixture was obtained. This powder was then melted in a rotary unit designed for this purpose. This device consists of a pair of conventional screw conveyors, which are key to homogenizing the materials. This equipment is known as a Brabender

### Chamber.

It should be noted that, in the context of the present invention, reference is not made to the PVC polymer (homopolymer), resin or synonyms it represents, but rather to the formulation; that is, it contains several components, this is called a PVC resin-based formulation; having said the above, for a person skilled in the art, it will be understood that in this document, the concept of PVC refers to the formulation.

TABLE 2
Formulation of PVC plates.

Formula

| Raw material | A (%) | B (%) |
|---|---|---|
| PVC Resin Grade 1300F | 47.4 | 49.90 |
| TOTM | 0 | 8,983 |
| DOTP/Jayflex DIDP-E | 18.95 | 13,472 |
| Epoxidized soybean oil | 2.37 | 1 |
| Demostab P74 | 2.37 | 2.49 |
| Calcium carbonate | 18.95 | 19.96 |
| Apyral 60D micron 1500 | 4.74 | 0 |
| Antimony trioxide - Campine | 1.422 | 1.74 |
| Zinc oxide | 2.37 | 0 |
| Calcium stearate | 0.472 | 1 |
| UV(Tinuvin)(Hostavin) | 0 | 0.2 |
| Irganox/Songnox 1076-M | 0 | 0.022 |
| Bisphenol-A | 0 | 0.15 |
| Struktol TR-121 | 0.95 | 1.066 |

Note 1:
The formulation of each of the samples is carried out in the form of a list, a specific order is not necessary.
^{A, B} The formulation of A for evaluation without sliding agent, Struktol TR-121 is not added.
Note 2:
This study used data reported using a different type of PVC not presented in this work.

It should be noted that for polyethylene polymers (LLDPE and LDPE) and polypropylene (PP), only resin and sliding agent concentrations were used; a specific formula was not employed. That is, only two components were used.

### Brabender Camera

Plasti-Corder CW. Brabender Instruments, Inc., 50 E. Wesley Street S. Hackensack, Type: DR-2051, No. 0181 PE equipment was used to obtain the material mixture, as mentioned in the previous paragraph. The material is deposited in the mixing chamber (the zone where the screws are located) at temperatures of 170-190° C., depending on whether the thermoplastic material is PE or PVC, and for a mixing time of 300 seconds. Mixing continues until complete melting is observed within the chamber. Once this mixture is obtained, the material is transferred to the pressing zone. This process will give the characteristic shape of plates with known dimensions.

### Presses

G50H-18-CX Genesis Series Compression Press equipment was used. Once the mixed materials are obtained in the Brabender chamber, in this step a pressing process will be used (see Table 3), which consists on placing the obtained materials into steel molds that gave them a square shape; for this purpose, pressure was applied at a rate of 35 tons at a temperature of 177° C. for 60 seconds. After this step, the plates were cooled to 85° C. and then carefully removed from the mold using high-temperature gloves. The same procedure was used to manufacture plates made from polyethylene (LLDPE, LDPE, and PP). The obtained plates resembled a regular polygon with four equal sides, measuring 22.8 cm on each side, and a thickness of 0.17 cm or 70 mils (thousandths of an inch) across the entire surface.

TABLE 3
Press operation conditions for manufacturing thermoplastic plates.

| | T | Mixing |
|---|---|---|
| Resin | (° C.) | time |
| PVC | 170 | |
| LLDPE | 160 | 300 |
| LDPE | 160 | |
| PP | 190 | |

Operating conditions vary due to the physical properties of thermoplastic materials.

Coefficient of Friction (μ)

The coefficient of friction (CoF, μ) was evaluated using the GBPI-GM4 China instrument to measure the CoF for each plate. This involved cutting a square from the plate obtained in the previous process, using working times of 60 seconds for each measurement. The instrument determined two dimensionless values: Dynamic Friction (FD) and Static Friction (FE).

### Plate Preparation and Friction Coefficient Evaluation

Preparation of thermoplastic sheets made of polyvinyl chloride (PVC), linear low-density polyethylene (LLDPE), and low-density polyethylene (LDPE), so that it is important to mention that these types of thermoplastic polymers are used exclusively in the WIRE AND CABLES industry due to their specific properties, such as electrical properties, mechanical strength, and flowability, among others. Compared to other sectors, these properties provide unique characteristics to the final product. The thermoplastic materials described above were treated with anti-sliding agents or friction reducers. Those used in this document are commercially available and consist of three types of polysiloxanes, ethylene bis-stearamide, and stearyl erucamide.

The preparation of plates based on polymeric matrices were prepared according to the following Table 4.

TABLE 4
Thermoplastic resins and sliding agents used in this work.

| | Concentration [%] | | | | | | | | | |
|---|---|---|---|---|---|---|---|---|---|---|
| | Commodity polymer | | | | | Sliding Agent | | | Ethylene | |
| | PVC ^{a} | | PE ^{b} | | | Polysiloxanes ^{d} | | | bis | Stearyl |
| No. | a′ | a″ | b′ | b″ | PP ^{c} | I ^{d′} | II ^{d″} | III ^{d′″} | stearamide^{f} | erucamide^{e} |
| 1 | | | 100 | 100 | | 0.0 | 0.0 | | | |
| 2 | | | 99 | 99 | | 1.0 | 1.0 | | | |
| 3 | | | 97.5 | 97 | | 2.5 | 3.0 | | | |
| 4 | | | 96 | 95 | | 4.0 | 5.0 | | | |
| 5 | | | 95 | 93 | | 5.0 | 7.0 | | | |
| 6 | | | 94 | | | 6.0 | | | | |
| 7 | | | 92 | | | 8.0 | | | | |
| 8 | | | 90 | | | 10 | | | | |
| 9 | | | 85 | | | 15 | | | | |
| 10 | | | 80 | | | 20 | | | | |
| 11 | | | 97 | | | | 3.0 | | | |
| 12 | — | — | 95 | | | | 5.0 | | | |
| 13 | | | 93 | | | | 7.0 | | | |
| 14 | | | 90 | | | | 10.0 | | | |
| 15 | | | 99.9 | | | | | 0.1 | | |
| 16 | | | 99.5 | | | | | 0.5 | | |
| 17 | | | | | 99.9 | | | 0.1 | | |
| 18 | | | | | 99.5 | | | 0.5 | | |
| 19 | 100 | | | | | 0.0 | | | | |
| 20 | 99 | | | | | 1.0 | | | | |
| 21 | 95 | | | | | 5.0 | | | | |
| 22 | | | | | 100 | 0.0 | | | | |
| 23 | | | | | 99 | 1.0 | | | | |
| 24 | | | | | 95 | 5.0 | | | | |
| 25 | | | | | 100 | | | | | 0.0 |
| 26 | | | | | 99 | | | | | 1.0 |
| 27 | | | | | 95 | | | | | 5.0 |
| 28 | | | | | 100 | | | | 0.0 | |
| 29 | | | | | 99 | | | | 1.0 | |
| 30 | | | | | 95 | | | | 5.0 | |

^{a, b, c} commodity: Commonly generic names given to polymers produced in large tonnages, basic and/or economical.
a′, a″, b′, b″, ^{d}, ^{e}, ^{f}, ^{g}These are trade names; therefore, they are registered trademarks.
^{a} PVC; Polyvinyl chloride, with trade name:
a′, a″ [PVC Grade 1300 F]
^{b} PE; Polyethylene:
b′ Linear low-density polyethylene, with the trade name: [Dow ™ Electrical & Telecommunications DFDA-7530 NT];
b″ Low-density polyethylene, with the trade name: [Dow ™ Electrical & Telecommunications DFDA-1216 NT]
^{c} PP; Polypropylene, with trade name: WP14-PTGPPH 12
^{d} Polysiloxanes:
^{d′} I, with trade name: Javachem GT300;
^{d″} II, with trade name: Javachem GT600;
^{d′″} III, with trade name: Tegopren 6846.
^{Stearyl}erucamide: trade name: Finawax SE
^{F} Ethylene bis erucamide: trade name: Licowax C
NF: Not formulated
Note:
PVC Formulation 1.1 a′, PVC Formulation 1.3 a″, Formulation 1.1 b will be assigned

### Physical Properties of Sliding Agents

The physical properties of sliding agents are relevant because they have unique or inherent characteristics that differentiate them; some of these materials have thermal properties, “sliding power”, this concept is an internal reference due to the results presented later (low values of friction coefficients; that is, less than 0.5 units). This value is referenced.

According to the Detailed Description of the Invention section in b) at least one additive with highly sliding characteristics; i-vii. The directions and recommendations in which the sliding agents are applied are presented.

In the samples of PVC compound UM83 with the sliding agent (red line), the presence of this additive is observed. This is confirmed at wavelengths of 1632 cm⁻¹, where the chemical bond corresponds to C═C. Further to the left of the same red line, the —C═C bond is present at 3177 cm⁻¹. Following the same red line, but at wavelengths of 3363 cm⁻¹. The presence of the C═O bond is also observed at wavelengths of 1720 cm⁻¹. It should be noted that this value is typical and can be found in other additives of the PVC compound. Finally, the presence of the NH bond, which is characteristic of secondary amides, is found; therefore, this indicates the chemical presence of oleamide.

### Results

In this evaluation, plates were prepared using PVC Formulation 1.3 and PVC Formulation 1.1 as described in Table 1 (methodology). The test consisted of evaluating the coefficient of friction (CoF, p) to each of the samples. The Struktol TR-121 additive was used as a sliding agent in both PVC-based plates. The coefficient of friction was also evaluated in the PVC samples without the sliding agent. A PVC-based resin was used as a reference for this study. The results obtained in this test are presented below. For this purpose, samples of two types of PVC were manufactured: Formulation 1.1 and Formulation 1.3—samples without and with the additive—obtaining the following average results, as described in Table 5.

TABLE 5
Friction gradient for each surface composed
of PVC additive Struktol TR-121.

Coefficient of friction

| PVC | X̅, FE^{c} | X̅, FD^{d} |
|---|---|---|
| Formulation 1.1 ^{a} | 0.716 | 1.206 |
| Formulation 1.1 ^{b} | 0.578 | 0.317 |
| Formulation 1.3 ^{b} | 0.448 | 0.206 |
| Formulation 1.4 ^{e} | 0.693 ^{e} | 0.776 ^{e} |

Three repetitions were performed for each of the PVC samples.
^{a} Without Struktol TR-121
^{b} Added Struktol TR-121
^{c}FE: Static friction
^{d}FD: Dynamic friction
^{e} Previously reported data. They were not evaluated in this work

From the manufactured plates, a total of three repetitions were carried out, averaging each of these in order to evaluate the CoF.

Regarding the PVC Formulation 1.1 sample without any additive, it showed a μ=1.206; this is because there are no hydrocarbon groups (the molecular structure of the sliding additive) present on the plate surface; that is, there is greater friction between the material plates. Meanwhile, with the addition of TR-121, a reduction of approximately four times its initial value was observed; that is, without the additive. These results indicate incorporation of the additive through the plate surface during processing.

On the other hand, without the PVC sliding agent, Formulation 1.3 showed reductions in CoF according to the report and the previous material (Formulation 1.1). This discrepancy in the results regarding the influence of the additive can be attributed to multiple factors, such as surface chemistry, contact time, and sliding speed. Finally, test data for PVC Formulation 1.4 were provided, showing values below μ=0.8, indicating reductions in CoF.

The results of the influence of the sliding agent on polymer matrices are presented below.

### Influence of the Sliding Agent Polysiloxane-III.

Polysiloxane-III (EVONIK) has been studied. However, due to its chemical and physical properties, this component has been recommended and used at concentrations lower than 0.5 wt. %. In this chemical structure, the supplier has maintained it as a Trade Secret; however, it has been briefly disclosed that it is a polyester-type chemical structure.

The following paragraphs present the results obtained for this sliding agent.

FIG. 4 presents the results obtained from the friction coefficients at two concentrations in wt. % of Polysiloxane-III sliding agent in thermoplastic polymer bases of linear low-density polyethylene, polypropylene, polyvinyl chloride and crosslinked polyethylene.

The graph above shows the increase in the friction coefficients of the polypropylene (PP) polymer base samples at a concentration of 0.1 wt. % over the two days of the study. It should be noted that the study could not be carried out at a concentration of 0.5 wt. % because, at higher concentrations, mixing was not achieved due to the strength of the oily physical properties, and this effect was most evident on the internal metal walls of the mixing equipment. That is to say, when the plates made contact (plate to plate), wear was observed on the surfaces pf the faces where the measurements were taken; this effect is due to the absence of the sliding additive within the polypropylene polymer matrix.

In the case of the 0.1 wt. % concentration, this result increases due to the degradation of polysiloxane-III, since this effect is caused by the heat treatment of the material during resin mixing or processing; that is, the optimal temperature for this sliding agent is 60-70° C., while the working temperature of polypropylene is around 180-200° C. When melting the polypropylene in the mixing equipment, it is at this temperature range that the loss of effectiveness of the sliding agent was observed due to its chemical properties; this indicates that the effectiveness of polysiloxane-III is not adequate for processing this type of polymer. Therefore, increases in friction values were observed, which are due to the loss of the sliding additive during the manufacturing process.

On the other hand, the graph shows the results obtained for the sliding agent Polysiloxane-I in a thermoplastic polymer matrix of linear low-density polyethylene as a function of the sliding agent concentration (in percent) and time (expressed in hours). This graph also shows the results for the thermoplastic commodity polymer matrices used, such as polyvinyl chloride (PVC), linear low-density polyethylene (LLDPE), low-density polyethylene (LDPE), and polypropylene (PP), as a function of the previously mentioned additives; for example, three classes of Polysiloxanes (I, II, and III), ethylene bis-stearamide, and stearyl erucamide, as a function of the previously mentioned weight percent (wt. %) concentrations.

Many modifications and other embodiments of the invention will occur to a person skilled in the art to which the invention pertains, having the benefit of the knowledge presented in the preceding description and associated drawings. It is therefore to be understood that the invention is not to be limited to the specific embodiments and examples described, but that modifications and other embodiments are intended to be included within the scope of the appended claims. Although specific terms are used herein, they are used only in a generic and descriptive sense and not for limiting purposes. It is also to be understood that the raw materials from which the various components comprising the invention described herein may be manufactured, and other elements may vary without departing from the scope and spirit of the invention, and therefore the embodiments referred to herein should not be considered limiting.

1. A thermoplastic coating composition with sliding properties for cables, comprising:
a) at least one base polymer;
b) at least one additive with sliding characteristics;
c) at least one UV stabilizer;
characterized in that the at least one base polymer is present in a range of 70% to 90% in the composition;
the at least one additive with sliding characteristics is present in a range from 0.01% to 15% of the total composition;
the at least one UV stabilizer is present in a range from 0.2% to 1% of the total composition.

2. The composition according to claim 1, wherein the at least one base polymer is selected from the group comprising polyvinyl chloride (PVC), polyethylene (PE), high-density polyethylene (HDPE), low-density polyethylene (LDPE), linear low-density polyethylene (LLDPE), polypropylene (PP), polyamides (PA, Nylon), combinations thereof and/or similar.

3. The composition according to claim 1, wherein the at least one base polymer comprises a dielectric strength in the range of 20 to 40 kV/mm.

4. The composition according to claim 1, wherein the at least one base polymer comprises a dielectric strength in the range of 30 to 50 kV/mm.

5. The composition according to claim 1, wherein the at least one base polymer comprises a density in the range of 1.3 to 1.45 g/cm³.

6. The composition according to claim 1, wherein the at least one base polymer comprises a density in the range of 0.915 to 0.930 g/cm³.

7. The composition according to claim 1, wherein the at least one additive with sliding characteristics includes any selected from the group comprising Stearyl Erucamide, Behemide, Erucamide, N,N′ ethylene Bisoleamide (EBO), Stearamide, Ethylene bis stearamide (EBS), silicone additives such as silanes and siloxanes, combinations thereof and/or similar.

8. The composition according to claim 7, wherein Stearyl Erucamide is present in a range from 0.1% to 5% concentration in the final composition.

9. The composition according to claim 7, wherein Stearyl Erucamide is present in a preferred range from 0.5% to 2% concentration in the final composition.

10. The composition according to claim 7, wherein Behemide is present in a range from 0.01% to 2% concentration in the final composition.

11. The composition according to claim 7, wherein the Behemide is present in a preferred range from 0.1% to 1% concentration in the final composition.

12. The composition according to claim 7, wherein Erucamide is present in a range from 0.1% to 8% concentration in the final composition.

13. The composition according to claim 7, wherein Erucamide is present in a preferred range from 1% to 5% concentration in the final composition.

14. The composition according to claim 7, wherein the N,N′ ethylene Bisoleamide (EBO) is present in a range from 0.01% to 5% concentration in the final composition.

15. The composition according to claim 7, wherein the N,N′ ethylene Bisoleamide (EBO) is present in a preferred range from 0.1% to 5% concentration in the final composition.

16. The composition according to claim 7, wherein Stearamide is present in a range from 0.01% to 2% concentration in the final composition.

17. The composition according to claim 7, wherein the Stearamide is present in a preferred range from 0.1% to 1% concentration in the final composition.

18. The composition according to claim 7, wherein Ethylene bis stearamide (EBS) is present in a range from 0.01% to 2% concentration in the final composition.

19. The composition according to claim 7, wherein Ethylene bis stearamide (EBS) is present in a preferred range from 0.1% to 1% concentration in the final composition.

20. The composition according to claim 7, wherein the silicone additives are present in a range from 0.1% to 15% concentration in the final composition.

21. The composition according to claim 7, wherein the silicone additives are present in a preferred range from 0.5% to 10% concentration in the final composition.

22. The composition according to claim 7, wherein the silanes act as coupling agents and the siloxanes reduce surface friction, being configured to be formulated in silicone emulsions.

23. The composition according to claim 1, wherein the at least one UV stabilizer is selected from the group comprising UV (UVA) absorbers such as benzophenones, benzotriazoles, triazines, combinations thereof and/or similar.

24. The composition according to claim 1, wherein the at least one UV stabilizer is selected from the group comprising free radical scavengers (HALS) such as hydroxybenzoates, Bis 2,2,6,6-tetramethyl-4-piperidyl, oxalanilides, carboxylic acid compounds, phosphites, arylsulfuric acids, combinations thereof and/or similar.

25. The composition according to claim 1, wherein the at least one UV stabilizer is in a preferred range from 0.3% to 0.8% concentration in the final composition.

26. A method for manufacturing a high-sliding coated cable, the method using the composition according to claim 1; the method comprising the steps of:
a) prepare the materials, which includes the following steps:
a.1) perform the dosage of the at least one base polymer and the at least one additive with sliding characteristics;
b) mix and homogenize the materials from step a), which comprises the steps of:
b.1) apply high shear to evenly distribute the additives in the polymer matrix;
b.2) heat the mixture until it reaches a molten state;
c) extruding the mixture, which comprises the steps of:
c.1) passing the molten mixture through an extrusion nozzle over a cable conductor;
d) cooling and solidifying, which comprises the steps of:
d.1) apply a controlled cooling system to the coated cable to prevent deformation; and
e) wind and cut the resulting coated cable.

27. The method according to claim 26, wherein step b.1) is performed using a Henschel-type high shear mixer.

28. The method according to claim 26, wherein step b.2) is performed using a Brabender-type screw mixing equipment.

29. The method according to claim 26, wherein step b.2) is performed at a temperature in a range from 170° C. to 190° C.

30. The method according to claim 26, wherein step b.2) is performed during a mixing time of 300 seconds.

31. The method according to claim 26, wherein for formulations comprising PVC, the mixing step b) comprises the sequential steps of: adding plasticizer at 75° C., adding fillers at 90-95° C. and discharging at 115° C.

32. The method according to claim 26, wherein for formulations comprising linear low-density polyethylene (LLDPE) or low-density polyethylene (LDPE), the operating temperature is 160° C.

33. The method according to claim 26, wherein for formulations comprising Polypropylene (PP), the operating temperature is 190° C.

34. The method according to claim 26, wherein step b.1) is performed at a stirring speed of 3400 rpm for powder formulations.

35. A use of the thermoplastic coating composition according to claim 1, for application in the manufacture of cable coatings requiring reduction of the coefficient of friction without external lubricants.

36. The use according to claim 35, wherein the cable is selected from the group comprising low voltage electrical cables, medium voltage electrical cables, cables for telecommunications, cables for medical applications, cables in automotive harnesses, aerospace control and communication cables, cables for industry 4.0, cables for industrial robotics, cables for 3D printing and CNC devices, and cables for the utilization of renewable energies.
